(19) United States
(12) Patent Application Publication
(10) Pub. No.: US 2009/0097366 A1
(43) Pub. Date: Apr. 16, 2009

(54) OPTICAL DISC APPARATUS AND LENS SHIFT CORRECTION METHOD OF OPTICAL DISC APPARATUS

(76) Inventor: Mikio YAMAMURO, Yokohama-shi (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/031,192

(22) Filed: Feb. 14, 2008

(30) Foreign Application Priority Data
Oct. 12, 2007 (JP) 2007-266731

(51) Int. Cl. G11B 7/00

(52) U.S. Cl. 369/44.32

(57) ABSTRACT

An optical disc apparatus includes a first lens shift amount detection unit which detects a first lens shift amount for a objective lens, on the basis of a push-pull signal which is generated in a state in which a main body of the optical disc apparatus is horizontally disposed, a memory unit which stores the first lens shift amount which is detected by the first lens shift amount detection unit, a second lens shift amount detection unit which detects a second lens shift amount for the objective lens on the basis of the push-pull signal at a time of recording/reproduction on/from an optical disc, and an addition unit which constantly adds to a tracking actuator of the objective lens a lens shift corresponding to a difference between the first lens shift amount stored in the memory unit and the second lens shift amount.

### CROSS-REFERENCE TO RELATED APPLICATIONS

This application is based upon and claims the benefit of priority from prior Japanese Patent Application No. 2007-266731, filed Oct. 12, 2007, the entire contents of which are incorporated herein by reference.

### BACKGROUND OF THE INVENTION

1. Field of the Invention

The present invention relates to an optical disc apparatus which executes position correction of an objective lens, and a lens shift correction method of an optical disc apparatus.

2. Description of the Related Art

In an optical disc apparatus, position correction of an objective lens of an optical pickup head is performed (for example, Jpn. Pat. Appln. KOKAI Publication No. 7-50021 and Jpn. Pat. Appln. KOKAI Publication No. 2002-304752).

In an optical information processing apparatus disclosed in Jpn. Pat. Appln. KOKAI Publication No. 7-50021, an objective lens is moved to a center position of a light beam, which is a reference position at the center of the objective lens, on the basis of an output signal from position detection means for detecting the position of the objective lens. Then, the objective lens is slightly vibrated near the reference position of the objective lens. Based on a tracking error signal at this time, an offset of the tracking error signal is detected. The tracking error signal is corrected on the basis of the detected offset amount.

In an optical disc apparatus disclosed in Jpn. Pat. Appln. KOKAI Publication No. 2002-304752, an objective lens of an optical pickup is inclined relative to the optical axial center, and the objective lens position is optimized so as not to adversely affect the quality of reproduction/recording. The optical disc apparatus disclosed in Japanese KOKAI No. 2002-304752 is configured such that the position of the objective lens is arbitrarily movable relative to output light of a light source. Using a trial write area of a recording type optical disc, the position of the objective lens, while being moved, is recorded. An optimal objective lens position is detected from a parameter which is obtained by reproducing the recorded area or from a parameter which is obtained from reflective light during the recording. Thus, the objective lens position is corrected, and the objective lens is positioned at the optimal objective lens position.

As described above, Jpn. Pat. Appln. KOKAI Publication No. 7-50021 and Jpn. Pat. Appln. KOKAI Publication No. 2002-304752 disclose the techniques for correcting the position of the objective lens. However, in the techniques described in these publications, no consideration is given to the correction of the lens position in relation to a variation in attitude at the time of use of the optical disc apparatus. Specifically, when the attitude of the optical disc apparatus varies, the objective lens moves by its own weight and a lens shift occurs in the actuator. It is not possible, however, to correct the position of the objective lens relative to the lens shift.

### BRIEF SUMMARY OF THE INVENTION

According to an aspect of the present invention, there is provided an optical disc apparatus which executes tracking control for an objective lens by generating a push-pull signal, comprising: a first lens shift amount detection unit which detects a first lens shift amount for the objective lens, on the basis of the push-pull signal which is generated in a state in which a main body of the optical disc apparatus is horizontally disposed; a memory unit which stores the first lens shift amount which is detected by the first lens shift amount detection unit; a second lens shift amount detection unit which detects a second lens shift amount for the objective lens on the basis of the push-pull signal at a time of recording/reproduction on/from an optical disc; and an addition unit which constantly adds to a tracking actuator of the objective lens a lens shift corresponding to a difference between the first lens shift amount stored in the memory unit and the second lens shift amount.

According to the present invention, for example, at a time of step learning, a lens shift amount is stored on the basis of a push-pull signal which is generated in a state in which the main body of the optical disc apparatus is horizontally disposed. At a time of recording/reproduction of information on/from an optical disc, a lens shift corresponding to a difference between a lens shift amount, which is detected on the basis of the push-pull signal at this time, and a lens shift amount which is detected in the state in which the main body of the optical disc apparatus is horizontally disposed, is constantly added to a tracking actuator of the objective lens. Thereby, an influence of the objective lens, which shifts due to a variation of attitude, is eliminated, and the operation point of the objective lens can be corrected to an optimal position.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram showing the structure of an optical disc apparatus according to an embodiment of the present invention;

FIG. 2 is a block diagram showing a detailed structure relating to tracking control in the present embodiment;

FIG. 3 is a view for explaining application of a bias voltage to a control signal for controlling tracking in the embodiment;

FIG. 4A and FIG. 4B show the states of an objective lens 12, which correspond to a difference in disposition of the optical disc apparatus;

FIG. 5A and FIG. 5B show symmetries of main push-pull signals corresponding to the states of the objective lens 12 shown in FIG. 4A and FIG. 4B;

FIG. 6 is a view for explaining the symmetry of a main push-pull signal;

FIG. 7 shows an example of the symmetry of a main push-pull signal MPP at a time of detecting a lens shift amount in the state in which the optical disc apparatus is horizontally situated;

FIG. 8 shows the symmetry of a main push-pull signal which is detected at a time of an actual operation for an optical disc 10;

FIG. 9 shows the symmetry of a main push-pull signal at a time of step learning in the present embodiment;

FIG. 10 shows the symmetry of a main push-pull signal at a time of executing an operation for an optical disc in the present embodiment;

FIG. 11 shows the symmetry of a main push-pull signal in a case where a bias voltage V1 is added in the present embodiment;

FIG. 12 shows the symmetry of a main push-pull signal when a bias voltage V2 is added in the present embodiment;

FIG. 13 shows the symmetry of a main push-pull signal when a bias voltage V2 is further added in the present embodiment;

FIG. 14 shows the symmetry of a main push-pull signal when a bias voltage ΔV is added in the present embodiment; and

FIG. 15 shows the symmetry of a push-pull signal in order to explain a second detection method for detecting a zero-cross point in the present embodiment.

### DETAILED DESCRIPTION OF THE INVENTION

An embodiment of the present invention will now be described with reference to the accompanying drawings.

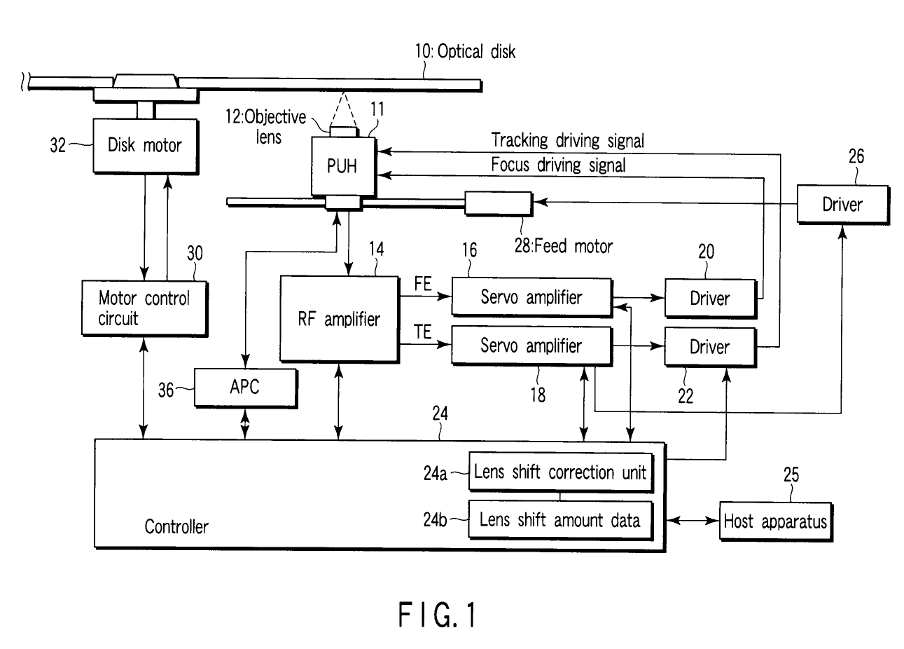

FIG. 1 is a block diagram showing the structure of an optical disc apparatus according to the embodiment.

A spiral track is formed on an optical disc 10 which serves as a recording medium. The optical disc 10 is rotated by a disc motor 32 (e.g. spindle motor) which is driven by a motor control circuit 30.

Recording/reproduction of data on/from the optical disc 10 is effected by a laser beam which is emitted from an optical pickup head (PUH) 11. The optical pickup head 11 is supported at a position facing a data read surface of the optical disc 10 in such a manner that the optical pickup head 11 is movable in a radial direction of the optical disc 10 by a feed motor 28 which is driven by a driver 26. The driver 26 is driven in accordance with a control signal which is generated by a servo amplifier 18.

The optical pickup head 11 includes a laser diode, a collimator lens, a beam splitter, an objective lens 12, a cylindrical lens, a photodetector, a lens position sensor and a monitor diode.

In addition, the optical pickup head 11 is provided with a biaxial actuator which moves the objective lens 12 in two mutually perpendicular directions. Specifically, the optical pickup head 11 is provided with a focusing actuator which adjusts focusing by moving the objective lens 12 in a focusing direction (i.e. an optical axis direction of the lens), and a tracking actuator which adjusts tracking by moving the objective lens 12 in a tracking direction (i.e. radial direction of the optical disc 10). The focusing actuator is controlled by a focus driving signal which is output from a driver 20. The tracking actuator is controlled by a tracking driving signal from a driver 22.

The laser diode of the optical pickup head 11 outputs a laser beam on the basis of a signal which is output from an Auto Power Control (APC) unit 36 under the control of a controller 24. Specifically, the APC unit 36 drives and controls the laser diode under the control of the controller 24. The APC unit 36 controls the ON/OFF of a laser output, and the intensity of the laser beam at a time of reproduction or at a time of recording. The laser beam that is output from the laser diode is radiated on the optical disc 10 via the collimator lens, beam splitter and objective lens 12.

Reflective light from the optical disc 10 is guided to the photodetector via the objective lens 12, beam splitter and cylindrical lens. The single photodetector comprises, e.g. four divided photodetectors. Signals that are detected by the four photodetectors are amplified to predetermined values and are output to an RF amplifier 14.

The RF amplifier 14 processes a signal from the photodetector of the optical pickup head 11 and outputs the processed signal. For example, the RF amplifier 14 generates and outputs a tracking error signal TE which indicates an error between a beam spot center of the laser beam and a track center, a focus error signal FE which indicates an error from a just-focus position, and an RF signal or an addition signal, in which the signals from the four divided photodetectors are added.

The focus error signal FE from the RF amplifier 14 is output to a servo amplifier 16, and the tracking error signal TE (e.g. Differential Push-Pull (DPP) signal) is output to a servo amplifier 18.

The servo amplifier 16 amplifies the focus error signal FE that is output from the RF amplifier 14, and outputs via the driver 20 a focus driving signal which drives the focusing actuator (not shown) of the optical pickup head 11.

The focusing actuator is driven by the focus driving signal that is output from the driver 20, and executes focus servo so that the laser beam from the optical pickup head 11 is made to be just focused on the recording surface of the optical disc 10.

The servo amplifier 18 amplifies the tracking error signal TE which is output from the RF amplifier 14, and outputs via the driver 22 a tracking driving signal which drives the tracking actuator (not shown) of the optical pickup head 11.

The tracking actuator is driven by the tracking driving signal that is output from the driver 22, and executes tracking servo so as to make the laser beam emitted from the optical pickup head 11 constantly trace the track that is formed on the optical disc 10. The driver 22 in the present embodiment can output, under the control of the controller 24, a tracking driving signal to which a bias voltage for constantly adding a lens shift, which corresponds to a preset value (lens shift amount data to be described later), is applied. The details will be described later.

The controller 24 is configured to include a processor and memories (RAM, ROM, flash memory). The controller 24 causes the processor to execute various programs stored in the memories, thereby executing an overall control of the apparatus.

The controller 24 in the present embodiment includes a lens shift correction unit 24a. The lens shift correction unit 24a stores lens shift amount data 24b which is measured in step learning that is executed in the fabrication process of the optical disc apparatus, and corrects the lens position of the objective lens 12 on the basis of the stored lens shift amount data 24b when data recording/reproduction for the optical disc 10 is actually executed. The lens shift amount data 24b, which is stored in the step learning, indicates a voltage value corresponding to a lens position (optical center point) at a zero-cross point of symmetry of a main push-pull signal which is generated in the state in which the optical disc apparatus body is horizontally disposed in a normal-temperature environment.

The host apparatus 25 outputs various commands to the optical disc apparatus, and controls the operation of the optical disc apparatus. The host apparatus 25 receives data that is read out from the optical disc 10 by the optical disc apparatus, and outputs data, which is to be recorded on the optical disc 10, to the controller 24.

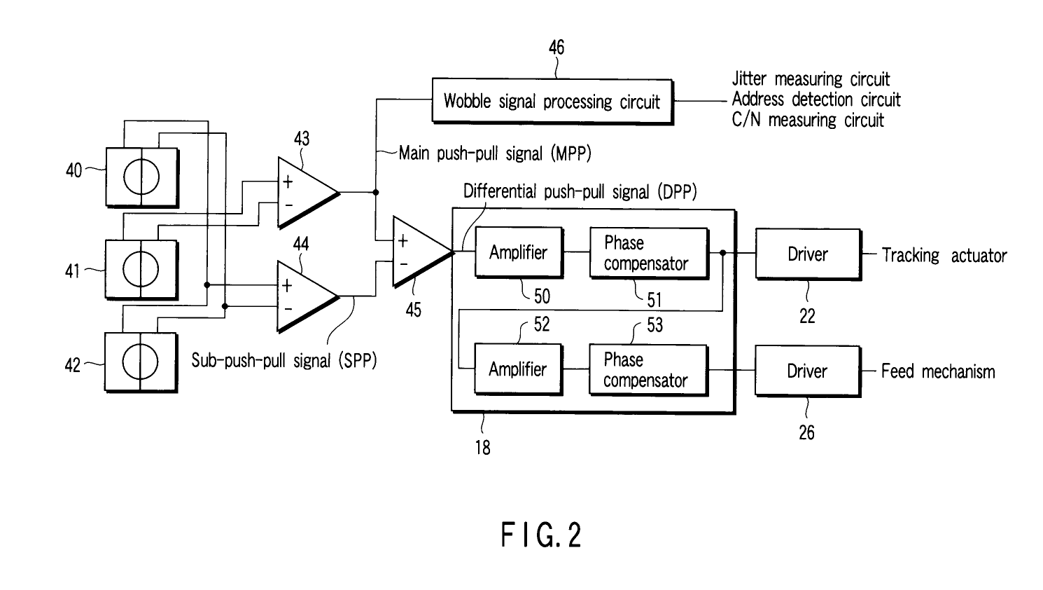

FIG. 2 is a block diagram showing a detailed structure relating to tracking control in the present embodiment.

In the optical disc apparatus according to the present embodiment, it is assumed that a push-pull signal is generated by a 3-beam structure. Specifically, a laser beam, which is output from the photodiode of the optical pickup head 11, is divided to three beams through a diffraction grating which is provided on the optical path, and the three beams are radiated through the objective lens 12 onto the optical disc 10 so as to form three spots. Reflective lights from the optical disc 10 are received by three photodetectors 40, 41 and 42. Each of the photodetectors 40, 41 and 42 shown in FIG. 2 is not a 4-division cell, but is depicted as being a 2-division cell for the purpose of convenience in order to explain the generation of the push-pull signal.

A signal from the photodetector 41 is output as a main push-pull signal (MPP) via a subtracter 43. Signals from the photodetectors 40 and 42 are output via a subtracter 44 as a sub-push-pull (SPP) signal. The main push-pull signal MPP and the sub-push-pull signal SPP are mixed by a subtracter 45 and are output to the servo amplifier 18 as a differential push-pull (DPP) signal.

The servo amplifier 18 receives the differential push-pull DPP, generates a control signal for controlling tracking by subjecting the differential push-pull DPP to amplification by an amplifier 50 and phase compensation by a phase compensator 51, and outputs the generated control signal to the driver 22. In accordance with the control signal from the servo amplifier 18, the driver 22 outputs a tracking driving signal to the tracking actuator of the optical pickup head 11.

The control signal, which has been subjected to the phase compensation by the phase compensator 51, is further subjected to amplification by an amplifier 52 and phase compensation by a phase compensator 53, and is output as a control signal to a PUH feed mechanism (driver 26, feed motor 28).

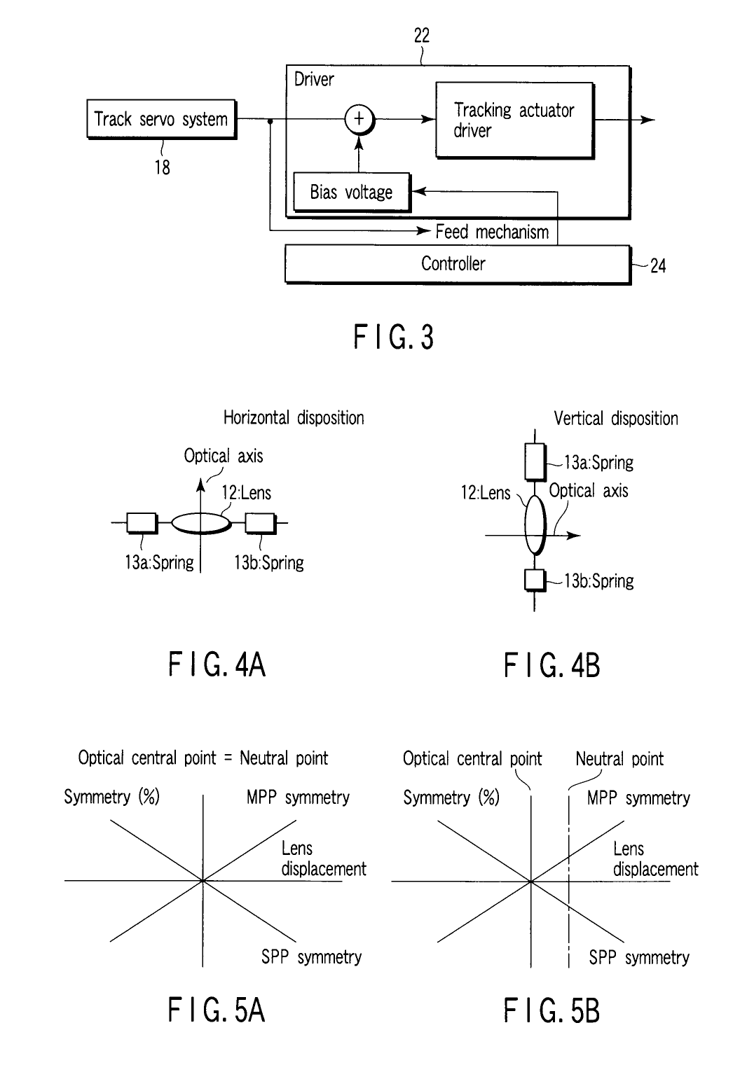

FIG. 3 is a view for explaining application of a bias voltage to a control signal for controlling tracking in the driver 22.

In the driver 22, a bias voltage for correcting a lens shift amount, which corresponds to an instruction from the controller 24 (lens shift correction unit 24a), is constantly applied. Thereby, the driver 22 outputs to the tracking actuator of the pickup head 11 a tracking driving signal which is obtained by constantly applying the bias voltage, which corresponds to the lens shift amount, to the control signal from the servo amplifier 18.

Next, the state of the objective lens 12, which varies depending on a difference in the state of disposition of the optical disc apparatus, is described.

FIG. 4A shows the objective lens 12 in the state in which the main body of the optical disc apparatus is horizontally disposed. For example, a plurality of springs 13a and 13b are mounted at end portions of the objective lens 12 that is provided in the optical pickup head 11, and the objective lens 12 is supported by the springs 13a and 13b. Since the plural springs 13a and 13b support the objective lens 12 with uniform force, the objective lens 12 is kept in the neutral state in the case where the optical disc apparatus is horizontally disposed.

FIG. 5A shows the symmetry of the main push-pull signal MPP (MPP symmetry) and the symmetry of the sub-push-pull signal SPP (SPP symmetry), which are generated when the objective lens 12 is in the state shown in FIG. 4A.

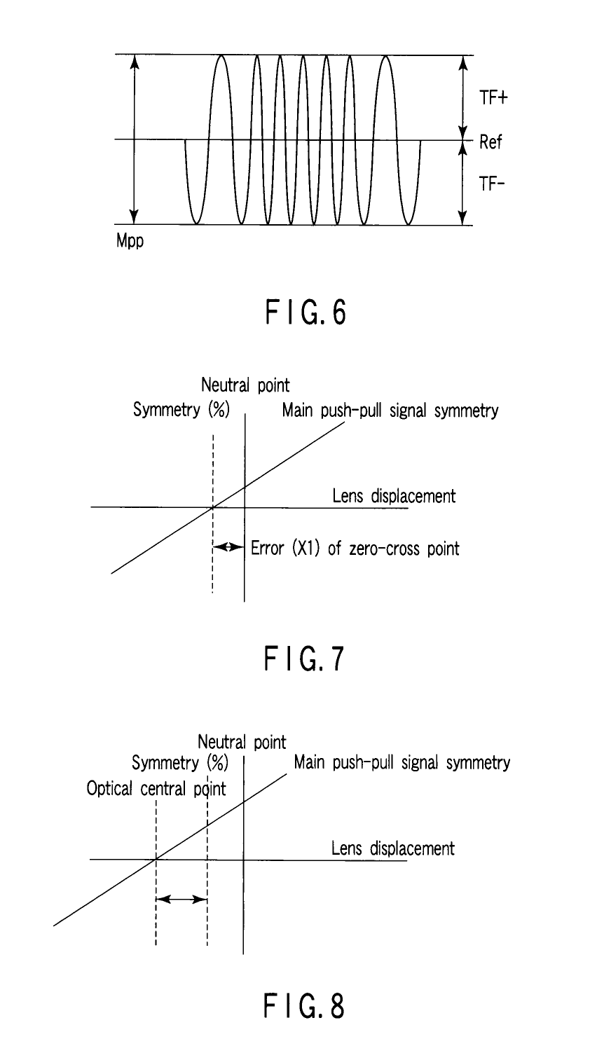

The symmetry of the main push-pull signal MPP is calculated by the following equation from a main push-pull signal MPP shown in FIG. 6:

MPP symmetry (%)={[(TE+)−(TE−)]/2}/MPP×100.

In the case where the objective lens 12 is kept in the neutral position as shown in FIG. 4A, the following symmetry is obtained. That is, as shown in FIG. 5A, the neutral point of the objective lens 12 agrees with the position (optical central point) where the objective lens 12 is shifted by the tracking actuator when the tracking of the objective lens 12 is executed in accordance with the tracking error signal TE(DPP signal). In this case, the power efficiency of the laser beam, which is radiated from the objective lens 12 onto the optical disc 10, is good. Moreover, since distortion of the shape of the beam spot hardly occurs, good optical quality is obtained.

Next, FIG. 4B shows the objective lens 12 in the state in which the main body of the optical disc apparatus is vertically disposed. When the optical disc apparatus is vertically disposed, the objective lens 12 moves downward from the normal neutral position by its own weight. Consequently, in the tracking actuator, there occurs a lens shift corresponding to a degree of the movement of the objective lens 12 by its own weight, and the tracking control is executed at the shifted lens position.

FIG. 5B shows the symmetry of the main push-pull signal MPP and the symmetry of the sub-push-pull signal SPP, which are generated in the case where the objective lens 12 is in the state shown in FIG. 4B. When the optical disc apparatus is vertically disposed as shown in FIG. 4B, the symmetry at this time indicates, as shown in FIG. 5B, that the objective lens 12 is shifted to a lens position where the neutral point of the objective lens 12 deviates from the optical central point. Consequently, as the optical central point becomes more away from the neutral point of the objective lens 12, that is, as the shift amount of the objective lens 12 becomes greater, the power efficiency or optical quality of the laser beam, which is radiated from the objective lens 12, become lower.

Next, the lens shift correction method of the optical disc apparatus according to the present embodiment is described.

To begin with, in the step learning process that is executed in the manufacturing process of the optical disc apparatus, the lens shift amount (optical central point) of the objective lens 12 at the time of executing tracking on the optical disc 10 is detected in the state in which the main body of the optical disc apparatus is horizontally disposed, and the detected lens shift amount is stored as lens shift amount data 24b in the controller 24. As shown in FIG. 2, the tracking actuator for the optical pickup head 11 is driven on the basis of the differential push-pull signal (DPP), and the objective lens 12 is shifted. In this case, it is assumed that the step learning process is executed in the normal-temperature environment in order to reduce a variation due to a change in temperature.

FIG. 7 shows an example of the symmetry of the main push-pull signal MPP at a time of detecting a lens shift amount in the state in which the optical disc apparatus is horizontally situated.

Ideally, it is preferable that the zero-cross point, which corresponds to the optical central point, agrees with the neutral point of the objective lens 12, as shown in FIG. 5A. Actually, however, the zero-cross point of the symmetry of the main push-pull signal MPP deviates from the neutral point, as shown in FIG. 7, due to the assembly precision of the optical pickup head 11, non-uniformity of parts, the influence due to temperature variation (e.g. deformation of the actuator), etc. The deviation of the zero-cross point varies from optical disc apparatus to optical disc apparatus.

The lens shift correction unit 24a of the controller 24 detects the lens shift amount corresponding to an error (X1) of the zero-cross point shown in FIG. 7, and stores the lens shift amount as the lens shift amount data 24b. Specifically, the lens shift correction unit 24a stores a driving voltage value for driving the tracking actuator to shift the objective lens 12 to the position corresponding to the zero-cross point, for example, in a flash memory as the lens shift amount data 24b. The error of the zero-cross point occurs due to various factors, as described above, and thus varies from optical disc apparatus to optical disc apparatus. Accordingly, the lens shift amount data 24b also varies from optical disc apparatus to optical disc apparatus.

After the lens shift amount data 24b is set in the step learning process, the optical disc apparatus is used by the user.

If the optical disc 10 is loaded in the optical disc apparatus and a recording or reproducing operation for the optical disc 10 is started, the lens shift amount data 24b of the controller 24 first detects the zero-cross point of the symmetry of the main push-pull signal MPP.

In the case where the user uses the optical disc apparatus, the optical disc apparatus is not always used in the horizontally situated state as in the case of the time of the step learning process. When the optical disc apparatus is not horizontally situated, the optical central point, i.e. the zero-cross point, disagrees with the neutral point of the objective lens 12 due to the influence of the weight of the objective lens 12 itself, as shown in FIG. 5B.

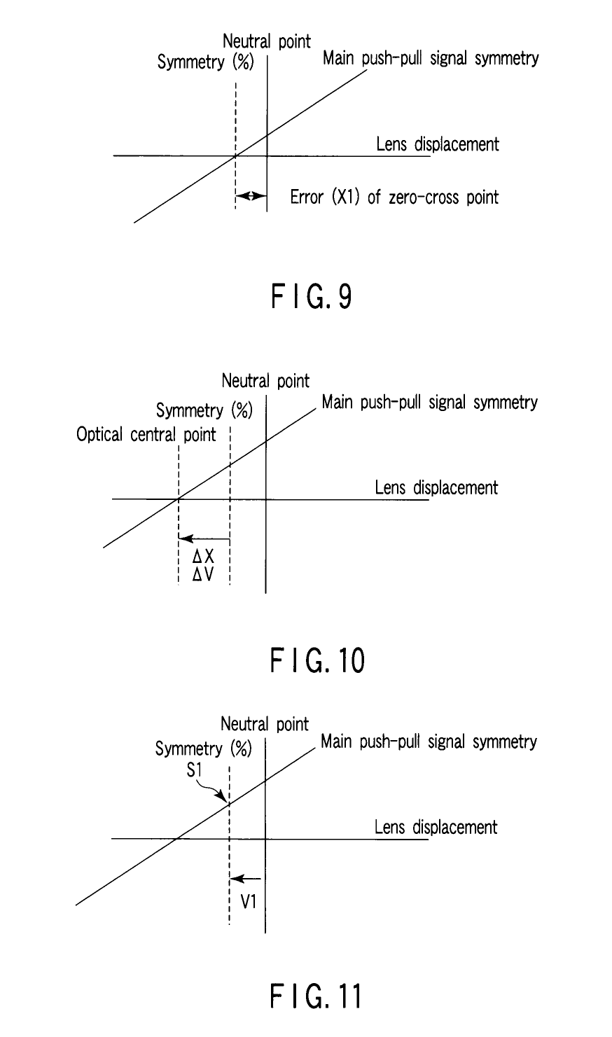

FIG. 8 shows the symmetry of the main push-pull signal MPP which is detected at the time of the actual operation for the optical disc 10. As shown in FIG. 8, an error of the zero-cross point due to the influence of the own weight of the objective lens 12, which results from the fact that the optical disc apparatus is not horizontally situated, is added to the error of the zero-cross point due to the influence of, e.g. temperature variation. The variation amount of the zero-cross point shown in FIG. 8 corresponds to the amount of the error of the optical central point due to the difference in the state of disposition of the optical disc apparatus.

In the present invention, the lens shift correction unit 24a of the controller 24 detects the lens shift amount corresponding to the zero-cross point at this time. A specific detection method for detecting the lens shift amount (voltage value) will be described later. The lens shift correction unit 24a operates to compare the lens shift amount corresponding to the zero-cross point at this time with the lens shift amount that was detected at the time of the step learning, and to constantly apply the bias voltage corresponding to the difference therebetween to the driver 22. The driver 22 is configured to output the tracking driving signal to which the bias voltage according to the instruction from the lens shift correction unit 24a is constantly applied, thereby driving the tracking actuator of the objective lens 12.

Specifically, the shift amount due to the own weight of the objective lens 12, which results from the fact that the optical disc apparatus is not horizontally situated, is corrected by outputting the tracking driving signal, to which the bias voltage corresponding to the shift amount, to the tracking actuator. Thereby, the optical central point can be shifted to the lens shift position where the zero-cross point, which is potentially possessed by the optical disc apparatus, deviates.

In the present embodiment, the lens shift for the objective lens 12 is corrected so as to shift the position of the zero-cross point of the main push-pull signal MPP. The reason is that the value of the symmetry of the main push-pull signal MPP varies even at the same lens shift position, other than the lens shift position that is the zero-cross point, depending on the kind of the optical disc 10 and depending on whether data is already recorded or not recorded on the optical disc 10. By correcting the position of the zero-cross point, it becomes possible to correct the lens shift that occurs due to the own weight of the objective lens 12, without influence by the optical disc 10 that is loaded in the optical disc apparatus.

Next, a description is given of the method of detecting the lens shift amount corresponding to the zero-cross point by the lens shift correction unit 24a.

To begin with, a first detection method is described. In the first detection method, the lens shift of a fixed amount is repeated until the polarity is reversed. Based on symmetry values before and after the reversal of polarity, the lens shift amount, which corresponds to the zero-cross point, is calculated.

FIG. 9 shows the symmetry of the main push-pull signal MPP at a time of the step learning. In FIG. 9, an error (X1) of the zero-cross point occurs from the neutral point of the objective lens 12.

The lens shift amount, which is obtained in this case, is measured by varying the bias voltage that is additionally applied to the driver 22. Thus, a voltage value V1, which indicates this bias voltage, is stored as the lens shift amount data 24b.

Assume now that the symmetry of the main push-pull signal MPP has varied, for example, as shown in FIG. 10, in the case where the optical disc apparatus actually executes the operation for the optical disc 10. Specifically, since the optical disc apparatus is not horizontally disposed, the lens shift occurs due to the own weight of the objective lens 12. In this procedure, the lens shift corresponding to the variation amount ΔX of the zero-cross point shown in FIG. 10 is executed, and the voltage value ΔV that is required for the lens shift is calculated.

To begin with, a voltage V1 (the value of the lens shift amount data 24b) is added, as a bias voltage that is stored at the time of the step learning, to the driver 22, and the value and polarity of the symmetry of the main push-pull signal MPP are examined.

FIG. 11 shows the symmetry of the main push-pull signal MPP in the case where the bias voltage V1 has been added. Assume that the symmetry value at the time when the bias voltage V1 is added is S1. In the case where the symmetry value S1 is substantially zero (the difference from zero is within the preset range), it is assumed that there is no variation from the time of the step learning, and the detection of the lens shift amount is finished.

As shown in FIG. 11, in the case where the symmetry value S1 is in the positive polarity, a bias voltage V2 is further added, and a symmetry value S2 and the polarity at this time are examined.

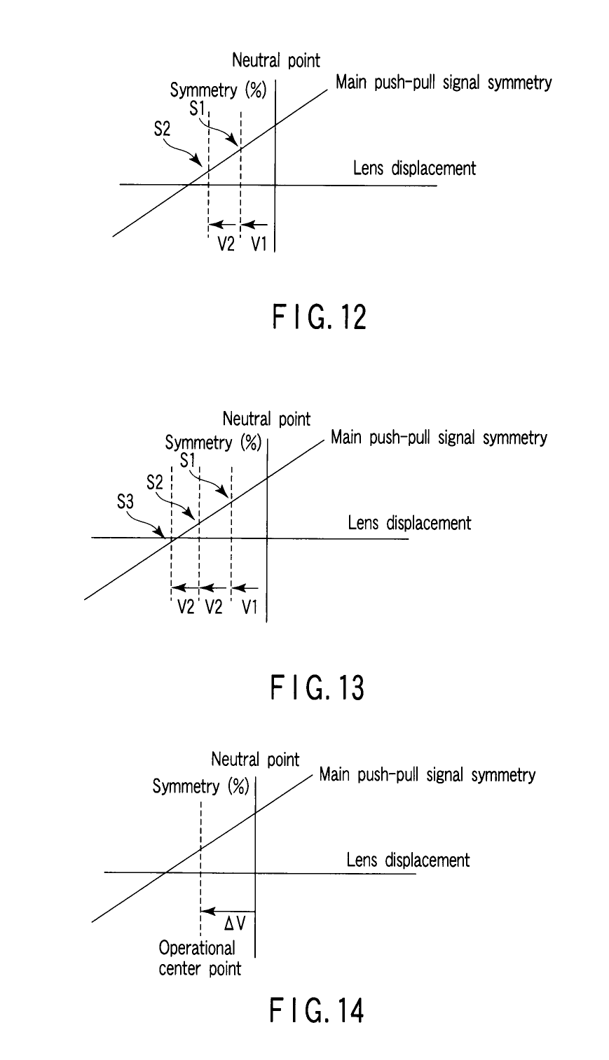

FIG. 12 shows the symmetry of the main push-pull signal MPP at the time when a bias voltage V2 is further added to the bias voltage V1. As shown in FIG. 12, in the case where the polarity of the symmetry value S2 is not reversed, an additional voltage V2 is further added to the bias voltages V1 and V2, and a symmetry value S3 and the polarity at this time are examined. In this manner, the same process as described above is repeatedly executed until the polarity of the symmetry value is reversed.

In the case where the polarity of the symmetry value S3 is reversed, as shown in FIG. 13, the lens shift amount, which corresponds to the zero-cross point, is calculated on the basis of the symmetry values before and after the reversal of the polarity.

Specifically, if it is assumed that the polarity is reversed between S(n) and S(n+1), the voltage value ΔV is calculated by using the following equations (n=1, 2, 3, . . . ):

In the case where S1<0,

ΔV=(n−1)×V2+(−S(n)/(S(n)+S(n+1))×V2.

In the case where S1>0,

ΔV=−(n−1)×V2−(−S(n)/(−S(n)+S(n+b 1))×V2.

As shown in FIG. 14, the voltage value ΔV that is thus obtained is applied to the driver 22 as a bias voltage, and the tracking actuator of the objective lens 12 is operated by the tracking driving signal that is output from the driver 22.

Next, a second detection method is described. In the second detection method, the lens shift in such a direction that the polarity is reversed is repeated with a gradually decreasing lens shift amount, and the lens shift amount, which corresponds to the zero-cross point, is calculated on the basis of the symmetry value that is obtained by the lens shift. In the second detection method, like a binary search method, the search range of the zero-cross point is successively restricted, and finally the zero-cross point is obtained.

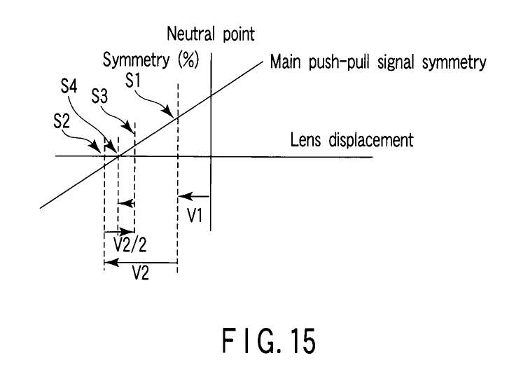

FIG. 15 shows the direction in which the bias voltage is added in the second detection method.

To begin with, V1 (the value of the lens shift amount data 24b) is added to the driver 22 as the bias voltage that was stored at the time of the step learning, and the value and the polarity of the symmetry of the main push-pull signal MPP are examined. In the case where the symmetry value S1 is substantially zero, it is assumed that there is no variation from the time of the step learning, and the detection of the lens shift amount is finished.

Subsequently, in the case where the symmetry value S1 at the time when the bias voltage V1 is added is in the positive polarity, a bias voltage V2, which is preset in such a direction as to be able to reverse the polarity of the symmetry value S, is added to the bias voltage V1, and the symmetry value S2 and the polarity at this time are examined. In the meantime, the bias voltage V2 is set at a value that is enough to reverse the polarity of the symmetry value S1 at the time when the first measured bias voltage V1 was added.

If the polarity is reversed, a bias voltage (−V2/2), which is half the bias voltage V2, is added to the bias voltages V1 and V2 in the opposite direction, and the symmetry value S3 and polarity at this time are examined. If the polarity is not reversed, a bias voltage (−V2/2), which is half the bias voltage V2, is added in such a direction as to be able to reverse the polarity, and the symmetry value S3 and polarity at this time are examined.

In this manner, the process of adding half the bias voltage in the direction, in which the polarity of the symmetry value can be reversed, and examining the symmetry value S and the polarity at this time is repeatedly executed.

In the example shown in FIG. 15, a bias voltage (+V2/4), which is half the bias voltage V2/2, is added in a direction opposite to the direction of the addition of the bias voltage V2, and the symmetry value S4 and the polarity at this time are examined.

In this manner, while the bias voltage is halved, the bias voltage is added in such a direction as to reverse the polarity of the symmetry value, and if the symmetry value S is substantially zero (i.e. the difference from zero is within the preset range), the bias voltage at this time is set at ΔV. In FIG. 15, the symmetry value S4 is observed as being substantially zero, and the voltage ΔV can be obtained by the following equation:

ΔV=V2−V2/2+V2/4.

Like the first detection method, the thus obtained voltage value ΔV is applied to the driver 22 as a bias voltage, and the tracking actuator of the objective lens 12 is operated by the tracking driving signal that is output from the driver 22.

In the above description of the second method, when the bias voltage is to be added, the voltage of the previously added voltage (<V2/2) is added. However, if the bias voltage is lowered, the voltage is not limited to the bias voltage of V2/2.

Next, a description is given of another method in a case where the lens shift amount (optical central point) is detected at the time of step learning.

In this case, the lens shift amount (optical central point) is detected on the basis of the quality of a wobble signal which is generated on the basis of the main push-pull signal MPP.

As shown in FIG. 2, using the main push-pull signal MPP, a wobble signal component is detected from the main push-pull signal MPP by a wobble signal processing circuit 46, and this wobble signal component is input to a jitter measuring circuit so that jitter can be measured.

In this state, in the step learning, the lens shift correction unit 24a of the controller 24 finds such a lens shift point as to minimize the jitter, while shifting the objective lens 12. Further, the lens shift correction unit 24a regards the found lens shift point as the optical central point, and stores the lens shift point. From the lens shift position (optical central point) that is found on the basis of the measurement result of jitter, the lens shift correction unit 24a detects the zero-cross point of the symmetry of the main push-pull signal MPP, and stores the difference of the lens shift amount as the lens shift amount data 24b.

Subsequently, when the operation for the optical disc 10 is actually executed, the above-described lens shift amount, which is regarded as the optical central point that is detected on the basis of the jitter, is first applied as the bias voltage. Further, the zero-cross point of the main push-pull signal MPP is detected. Then, the difference between the lens shift amount corresponding to the zero-cross point and the lens shift amount stored at the time of step learning is added to the lens shift value that is regarded as the optical central point, and the added value is applied to the tracking actuator of the objective lens 12 and the tracking actuator is constantly operated.

Thereby, even if the objective lens 12 lowers due to its own weight owing to the attitude of the optical disc apparatus that is disposed, recording/reproduction can always be executed at the optimal point of the wobble signal quality.

In the above description, the jitter has been exemplified in the determination of the wobble signal quality. However, in the case where address information is superimposed on the wobble signal, the reading rate of addresses may be checked and the optimal point at which the best reading rate is obtained may be regarded as the optical central point. An address detection circuit detects address information that is superimposed on the wobble signal, on the basis of the wobble signal that is generated by the wobble signal processing circuit 46. The address detection circuit detects the reading rate of the address information and outputs the detected value to the controller 24. The lens shift correction unit 24a of the controller 24 finds the lens shift position at which the best reading rate of address information is obtained, while shifting the objective lens 12. The reading rate of address information may be detected by the controller 24.

Besides, the determination of the quality of the wobble signal may be executed on the basis of a C/N (carrier to noise ratio). In this case, the wobble signal component is detected by the wobble signal processing circuit 46, and the detected signal component is input to the a C/N measuring circuit, and the measurement of the C/N is executed. Subsequently, in the same manner as described above, the lens shift position at which the optimal C/N is obtained is found and set to be the optical central point.

In this manner, when the optical disc apparatus is not horizontally situated, the lens shift amount, which occurs due to the own weight of the objective lens 12, is measured with reference to the lens shift position that is detected on the basis of the quality of the wobble signal. By driving the tracking actuator by applying thereto the bias voltage so as to correct the lens shift amount, the tracking can be executed in the state in which the best wobble signal quality is obtained.

In the above description, the lens shift amount data 24b is stored in the step learning in the manufacturing process of the optical disc apparatus. Alternatively, the lens shift amount data 24b may be set at a time other than the time of the manufacturing process. For example, after the optical disc apparatus is shipped, the setting of the lens shift amount data 24b may be executed in the initializing process at the time when the user first uses the optical disc apparatus.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An optical disc apparatus which executes tracking control for an objective lens by generating a push-pull signal, comprising:
a first lens shift amount detection unit which detects a first lens shift amount for the objective lens, on the basis of the push-pull signal which is generated in a state in which a main body of the optical disc apparatus is horizontally disposed;
a memory unit which stores the first lens shift amount which is detected by the first lens shift amount detection unit;
a second lens shift amount detection unit which detects a second lens shift amount for the objective lens on the basis of the push-pull signal at a time of recording/reproduction on/from an optical disc; and
an addition unit which constantly adds to a tracking actuator of the objective lens a lens shift corresponding to a difference between the first lens shift amount stored in the memory unit and the second lens shift amount.

2. The optical disc apparatus according to claim 1, wherein a main push-pull signal and a sub-push-pull signal are generated by a 3-beam method,
the first lens shift amount detection unit detects the first lens shift amount, with which symmetry of the main push-pull signal becomes a zero cross, and
the second lens shift amount detection unit detects the second lens shift amount, with which symmetry of the main push-pull signal becomes a zero cross.

3. The optical disc apparatus according to claim 2, further comprising:
a third lens shift detection unit which detects a third lens shift amount on the basis of a quality of a wobble signal which is included in the main push-pull signal, before the first lens shift amount is detected by the first lens shift amount detection unit; and
a second memory unit which stores the third lens shift amount which is detected by the third lens shift detection unit,
wherein the second lens shift amount detection unit detects the second lens shift amount on the basis of the main push-pull signal which is generated in a state in which a lens shift is executed in accordance with the third lens shift amount stored in the second memory unit.

4. The optical disc apparatus according to claim 3, wherein the third lens shift amount detection unit detects, as the third lens shift amount, a lens shift amount with which jitter of the wobble signal becomes optimal.

5. The optical disc apparatus according to claim 3, wherein the third lens shift amount detection unit detects, as the third lens shift amount, a lens shift amount with which a reading rate of address information included in the wobble signal becomes optimal.

6. The optical disc apparatus according to claim 3, wherein the third lens shift amount detection unit detects, as the third lens shift amount, a lens shift amount with which a C/N (carrier to noise ratio) relating to the wobble signal becomes optimal.

7. The optical disc apparatus according to claim 2, wherein the second lens shift detection unit repeatedly executes a lens shift of a fixed amount until polarity is reversed in a case where symmetry of the main push-pull signal, which is generated in a state in which a lens shift is executed with the first lens shift amount, is not zero, and calculates a lens shift amount, which corresponds to a zero-cross point, on the basis of symmetry values before and after the reversal of the polarity.

8. The optical disc apparatus according to claim 2, wherein the second lens shift detection unit repeatedly executes a lens shift in such a direction as to reverse polarity, while gradually decreasing a lens shift amount, in a case where symmetry of the main push-pull signal, which is generated in a state in which a lens shift is executed with the first lens shift amount, is not zero, and calculates a lens shift amount which correspond to a zero-cross point, on the basis of symmetry values which are obtained as a result of the lens shift.

9. An optical disc apparatus comprising:
an optical pickup head including at least an objective lens which radiates a laser beam on an optical disc, a photodetector which detects reflective light from the optical disc, and an actuator which moves the objective lens in a tracking direction of the optical disc;
an RF amplifier which generates a push-pull signal corresponding to the reflective light from the optical disc, which is detected by the photodetector of the optical pickup head;
a driver which controls tracking by outputting a driving signal for the actuator, on the basis of the push-pull signal that is output from the RF amplifier; and
a controller which outputs to the actuator a first driving signal corresponding to the push-pull signal which is generated in a state in which a main body of the optical disc apparatus is horizontally disposed at a time of step learning, thereby executing a lens shift, and stores a first voltage value of the first driving signal at this time in a memory, and constantly applies, at a time of recording/reproducing data on/from the optical disc, to the driver a bias voltage corresponding to a difference between a second voltage value of a second driving signal, which is output to the actuator on the basis of the push-pull signal, and the first voltage value that is stored in the memory, thereby driving the actuator.

10. A lens shift correction method for an optical disc apparatus, which corrects a position of an objective lens for which tracking control is executed on the basis of a push-pull signal, comprising:
detecting a first lens shift amount for the objective lens, on the basis of the push-pull signal which is generated in a state in which a main body of the optical disc apparatus is horizontally disposed;
storing in a memory the first lens shift amount which is detected;
detecting a second lens shift amount for the objective lens on the basis of the push-pull signal at a time of recording/reproduction on/from an optical disc; and
constantly adding to a tracking actuator of the objective lens a lens shift corresponding to a difference between the first lens shift amount stored in the memory and the second lens shift amount.
